(19) United States
(12) Patent Application Publication
(10) Pub. No.: US 2025/0007841 A1
(43) Pub. Date: Jan. 2, 2025

(54) THROUGHPUT PREDICTION, ANOMALY DETECTION, AND CORRECTION FOR UE POWER SAVING

(71) Applicant: Samsung Electronics Co., Ltd., Suwon-si (KR)

(72) Inventors: Anum Ali, Frisco, TX (US); Yuqiang Heng, Plano, TX (US); Vutha Va, Plano, TX (US); Priyabrata Parida, Dallas, TX (US); Boon Loong Ng, Plano, TX (US)

(21) Appl. No.: 18/401,253

(22) Filed: Dec. 29, 2023

Related U.S. Application Data
(60) Provisional application No. 63/524,170, filed on Jun. 29, 2023.

(51) Int. Cl. H04L 47/12; H04L 43/0888

(52) U.S. Cl. CPC H04L 47/12; H04L 43/0888

(57) ABSTRACT

A method of operating a UE includes receiving and transmitting traffic, over a time step, based on a first set of RF parameters received from a NW device. The method further includes classifying the traffic received and transmitted over the time step into a traffic class, selecting a second set of RF parameters based on the traffic class, estimating a throughput demand and a throughput supply, and determining, based on the estimated throughput demand and the estimated throughput supply, whether an anomalous traffic condition has occurred. The method further includes, if an anomalous traffic condition has not occurred, transmitting a request to the NW device to configure the UE with the second set of RF parameters, and if an anomalous traffic condition has occurred, transmitting a request to the NW device to configure the UE with a third set of RF parameters selected to alleviate the anomalous traffic condition.

### CROSS-REFERENCE TO RELATED APPLICATION(S) AND CLAIM OF PRIORITY

This application claims priority under 35 U.S.C. § 119 (e) to U.S. Provisional Patent Application No. 63/524,170 filed on Jun. 29, 2023. The above-identified provisional patent application is hereby incorporated by reference in its entirety.

### TECHNICAL FIELD

This disclosure relates generally to wireless networks. More specifically, this disclosure relates to apparatuses and methods for throughput prediction, anomaly detection, and correction for 5G UE power saving.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are being implemented at a rapid pace. However, such improvements often require higher power consumption by end user devices, and new techniques for increased battery life and/or reduced power usage are desirable.

### SUMMARY

The present disclosure provides apparatuses and methods for throughput prediction, anomaly detection, and correction for 5G UE power saving.

In one embodiment, a user equipment (UE) is provided. The UE includes a transceiver configured to receive and transmit traffic, over a time step, via a wireless network (NW), based on a first set of radio frequency (RF) parameters received from a NW device. The UE further includes a processor operably coupled to the transceiver. The transceiver is configured to classify the traffic received and transmitted over the time step into a traffic class, select a second set of RF parameters based on the traffic class, estimate a throughput demand and a throughput supply, and determine, based on the estimated throughput demand and the estimated throughput supply, whether an anomalous traffic condition has occurred. If an anomalous traffic condition has not occurred, the processor is configured to cause the transmitter to transmit a request to the NW device to configure the UE with the second set of RF parameters. if an anomalous traffic condition has occurred, the processor is configured to cause the transmitter to transmit a request to the NW device to configure the UE with a third set of RF parameters selected to alleviate the anomalous traffic condition.

In another embodiment, a method of operating a UE is provided. The method includes receiving and transmitting traffic, over a time step, via a wireless NW, based on a first set of RF parameters received from a NW device. The method further includes classifying the traffic received and transmitted over the time step into a traffic class, selecting a second set of RF parameters based on the traffic class, estimating a throughput demand and a throughput supply, and determining, based on the estimated throughput demand and the estimated throughput supply, whether an anomalous traffic condition has occurred. The method further includes, if an anomalous traffic condition has not occurred, transmitting a request to the NW device to configure the UE with the second set of RF parameters, and if an anomalous traffic condition has occurred, transmitting a request to the NW device to configure the UE with a third set of RF parameters selected to alleviate the anomalous traffic condition.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example of a CDRX operation according to various embodiments of this disclosure;

FIG. 5 illustrates an example of BWP switching and MIMO layers adaptation according to various embodiments of this disclosure;

FIG. 6 illustrates an example UAI framework according to embodiments of the present disclosure;

FIG. 7 illustrates an example procedure for throughput prediction and anomaly detection for 5G UE power saving according to embodiments of the present disclosure;

FIG. 8 illustrates an example probability distribution of MCS given CQI according to various embodiments of this disclosure;

FIG. 9 illustrates an example of sudden changes in throughput according to various embodiments of this disclosure;

FIGS. 10A-10B illustrate an example procedure for database maintenance for throughput demand estimation according to embodiments of the present disclosure;

FIG. 11 illustrates an example procedure for throughput demand prediction using mean and standard deviation;

FIG. 12 illustrates an example of a browsing throughput trace according to various embodiments of this disclosure;

FIG. 13 illustrates an example procedure 1300 for throughput demand prediction using percentiles;

FIG. 14 illustrates an example procedure for throughput observations at the PHY layer;

FIG. 15 illustrates an example of a trace of traffic with and without background traffic according to various embodiments of this disclosure;

FIG. 16 illustrates an example procedure for obtaining packet based throughput observations ignoring the background traffic;

FIG. 17 illustrates an example procedure 1700 for obtaining packet based throughput observations separately for RT and NRT traffic;

FIG. 18 illustrates an example method for throughput based anomaly detection and correction according to embodiments of the present disclosure;

FIG. 19 illustrates an example procedure for throughput prediction and anomaly detection for 5G UE power saving at the NW according to embodiments of the present disclosure; and

FIG. 20 illustrates a method for throughput prediction, anomaly detection, and correction for 5G UE power saving according to embodiments of the present disclosure.

### DETAILED DESCRIPTION

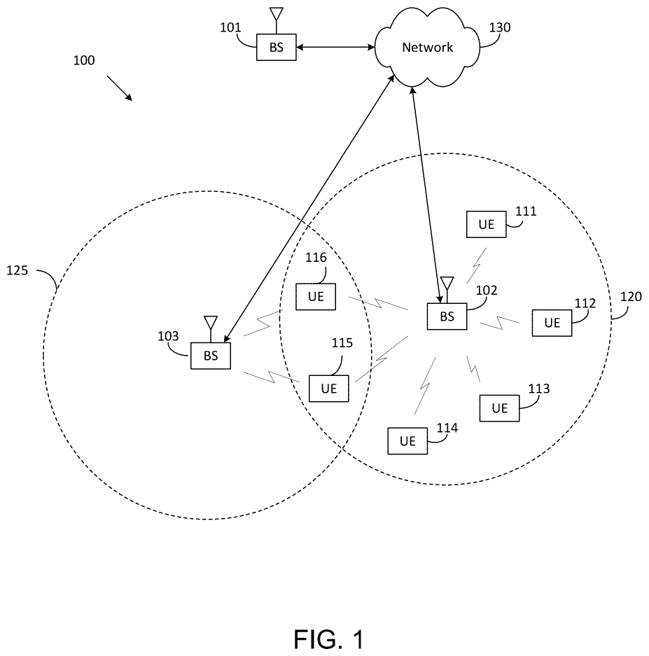

FIGS. 1 through 20, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for throughput prediction, anomaly detection, and correction for 5G UE power saving. In certain embodiments, one or more of the gNBs 101-103 includes circuitry, programing, or a combination thereof, to support throughput prediction, anomaly detection, and correction for 5G UE power saving in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

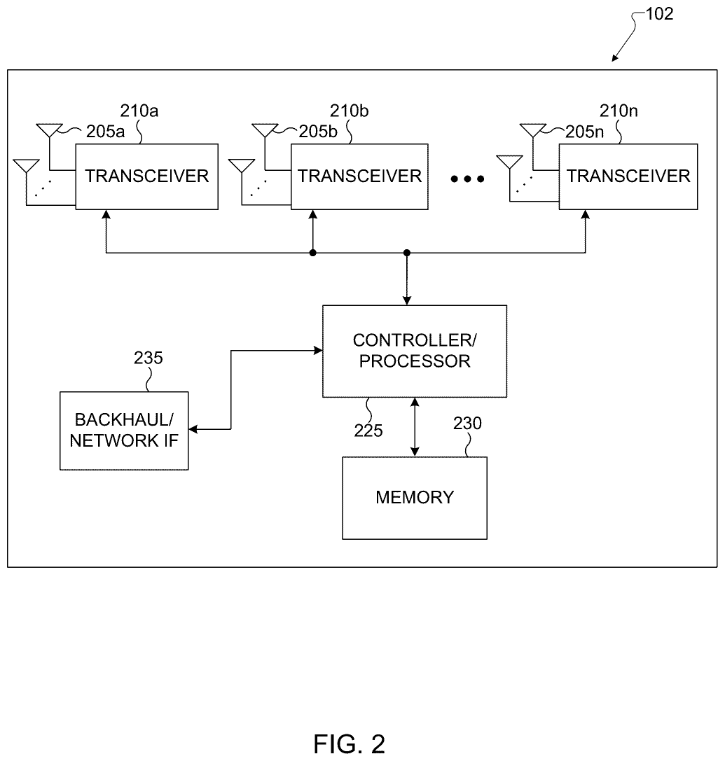

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235. Controller/processor 225 may also be referred to as an application processor (AP), a communications processor (CP), etc.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support throughput prediction, anomaly detection, and correction for 5G UE power saving as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

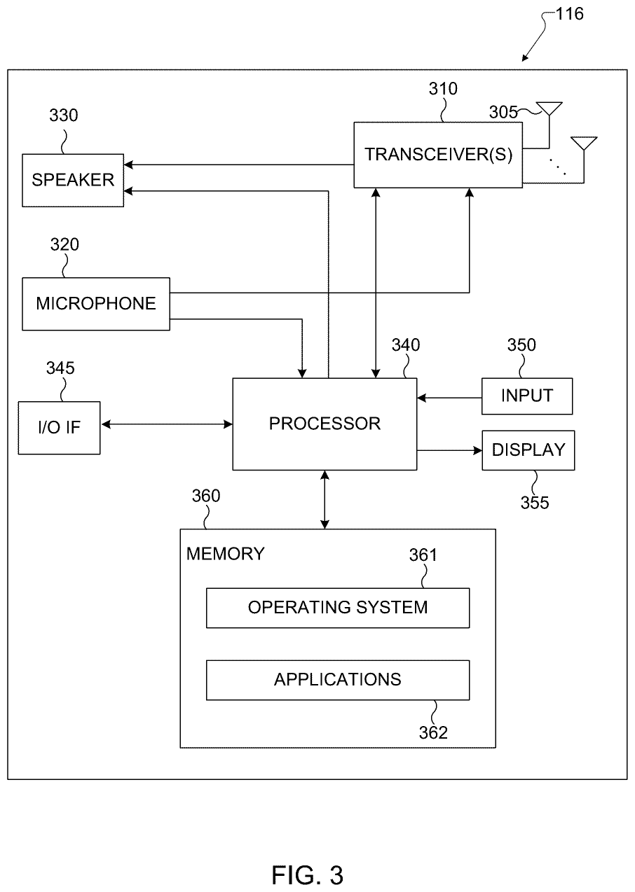

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362. Processor 340 may also be referred to as an application processor (AP), a communications processor (CP), etc.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for throughput prediction, anomaly detection, and correction for 5G UE power saving as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

The fifth generation (5G) of cellular communication, i.e., 5G new radio (NR) provides high data rates by the virtue of using large bandwidth and antennas. This, however, results in high power consumption at the UE. In Release 16 of 3GPP, the concept of UE assistance information (UAI) is introduced for UE power saving. Through UAI, the UE can share its preference on several RF parameters including the bandwidth and the number of antennas with the NW. This way if the UE is using applications requiring low throughput, it can request to use low bandwidth and/or antennas. The UE, however, needs to detect the level of throughput that the currently active application is likely to consume. Sudden changes in throughput or erroneous estimation from the UE mean that the RF parameters shared with the NW may not be able to meeting the quality of service (QOS) requirements of the currently active application.

In the present disclosure, a solution is provided to the anomalous behavior where the RF parameters determined by traffic classification cannot meet the throughput demand of the currently active application.

Several 5G UE power-saving techniques have been investigated by 3GPP. These techniques include cross-slot scheduling, bandwidth part (BWP) adaptation, discontinuous reception (DRX), radio resource control (RRC)—inactive mode, wakeup signal (WUS), two-step RACH, UE assistance information (UAI), etc. The UAI framework introduced in Release 16 allows a 5G UE to indicate its preference on several RF parameters to the network (NW), and as a result, influence its power consumption.

Traffic classification and subsequent determination of power saving parameters at the UE has been studied in the past for WiFi using target wake time (TWT). The TWT is a power-saving mechanism that enables a station (STA) an access point (AP) to negotiate when the STA will be awake to send and receive data. The wake period is adaptively configured based on the traffic type and its corresponding latency. In LTE, a single-bit power preference indication (PPI) was introduced. Using PPI, the UE could indicate its desire to enter a power-saving state to the NW. Essentially, the low power consumption state was a connected mode discontinuous reception (CDRX) configuration that permitted the UE to sleep for a longer duration. The CDRX parameters for the low power consumption state were determined by the NW.

The power consumption of a smartphone is due to multiple components, including the screen, processor, modem, and RF front end. Herein a brief introduction is provided to the UE power-saving strategies that are most relevant to the present disclosure.

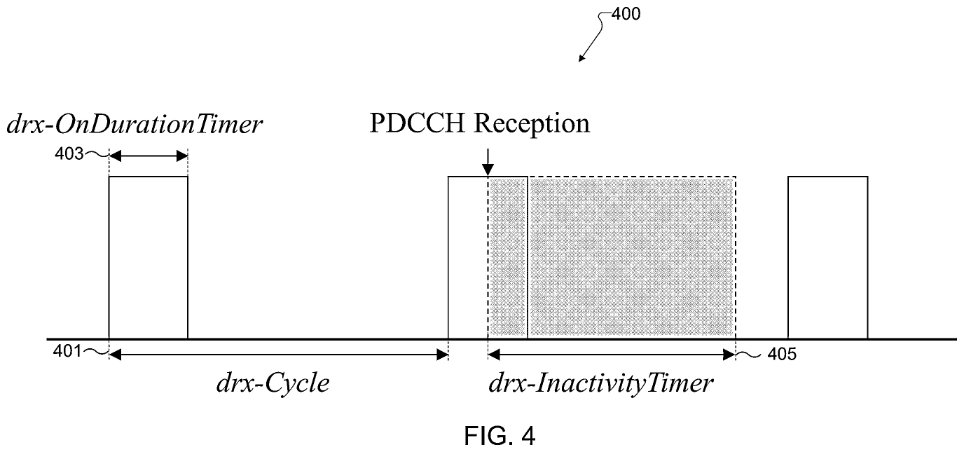

CDRX enables an RRC-connected UE to wake up periodically at predetermined intervals to monitor the physical downlink control channel (PDCCH). If there is no PDCCH, the UE enters a power-saving sleep state. CDRX is configured by the NW using RRC-configuration through three main parameters, namely drx-Cycle, drx-onDurationTimer, and drx-Inactivity Timer as illustrated in FIG. 4.

FIG. 4 illustrates an example of a CDRX operation 400 according to various embodiments of this disclosure. The embodiment of a CDRX operation in FIG. 4 is for illustration only. Other embodiments of a CDRX operation could be used without departing from the scope of this disclosure.

As illustrated in FIG. 4, the drx-Cycle parameter defines a periodicity 401 with which the UE wakes up. Once the UE wakes up, the UE monitors PDCCH during a time 403 defined by the drx-onDurationTimer parameter. If a PDCCH is not detected during the time 403 defined by drx-onDurationTimer, the UE goes back to sleep. Otherwise, the UE extends the DRX active time by a time 405 defined by the drx-Inactivity Timer parameter.

Although FIG. 4 illustrates one example of CDRX operation 400, various changes may be made to FIG. 4. For example, the length of drx-Cycle, drx-onDurationTimer, and drx-Inactivity Timer may vary, etc. according to particular needs.

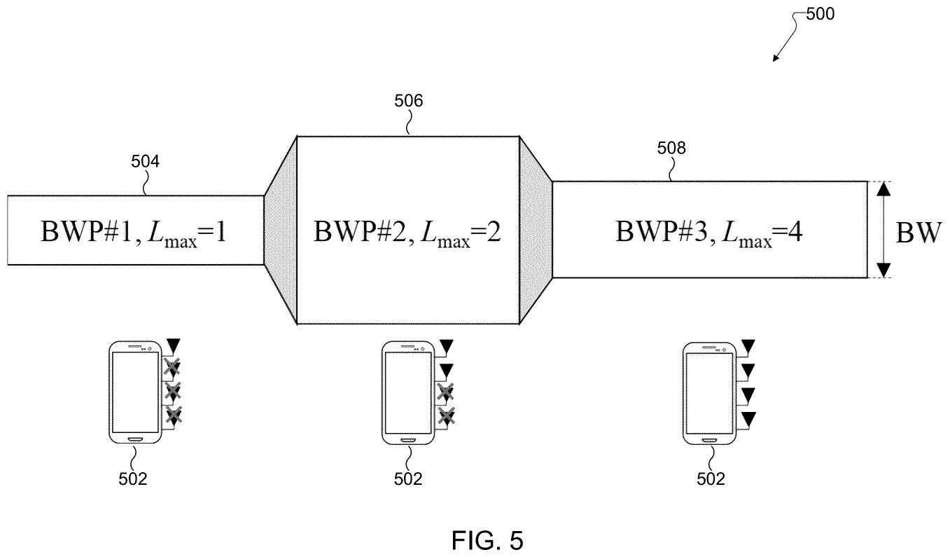

5G/NR supports several hundreds of MHz of bandwidth to provide high throughput. Operation with such bandwidth requires large Fourier transforms and a high-performance analog-to-digital converter (ADC). Since the UE does not require a high throughput at all times, the concept of bandwidth part (BWP) was introduced in 5G/NR. BWP refers to a portion of the system BW, over which the UE is configured to transmit and receive signals. The UE can be configured with up to 4 UL and DL BWPs, but only one BWP is active at any given time. The NW can switch the UE's active BWP among the configured BWPs via downlink control information (DCI). The switching of the BWP among multiple BWPs is illustrated in FIG. 5.

FIG. 5 illustrates an example of BWP switching and MIMO layers adaptation 500 according to various embodiments of this disclosure. The embodiment of BWP switching MIMO layers adaptation in FIG. 5 is for illustration only. Other embodiments of BWP switching MIMO layers adaptation could be used without departing from the scope of this disclosure.

In the example of FIG. 5, a BWP configuration of a UE 502 is depicted over a particular time span. During a portion of the time span 504, UE 502 is configured to transmit and receive signals over BWP #1. During a portion of the time span 506, the configuration of UE 502 is switched so that UE 502 is configured to transmit and receive signals over BWP #2. Finally, during a portion of the time span 508, the configuration of UE 502 is switched so that UE 502 is configured to transmit and receive signals over BWP #3.

Using a large number of antennas at the UE enables high throughput applications but incurs high power consumption. Hence, through antenna adaptation, the UE can save power when high throughput is not required. While using fewer antennas, the power savings come from turning off the RF components as well as skipping the channel estimation for the unused antennas. The maximum number of MIMO layers Lₘₐₓ can be adapted under the BWP framework. Specifically, multiple BWPs can be configured, each with a different Lₘₐₓ as illustrated in FIG. 5.

In the example of FIG. 5, a MIMO layer configuration of UE 502 is depicted over a particular time span. During the portion of the time span 504, UE 502 is configured with Lₘₐₓ=1 so that UE 502 may transmit and receive signals over only a single MIMO layer. During the portion of the time span 506, the configuration of UE 502 is switched to Lₘₐₓ=2 so that UE502 may transmit and receive signals over two MIMO layers. Finally, during the portion of the time span 508, the configuration of UE 502 is switched to Lₘₐₓ=4 so that UE 502 may transmit and receive signals over four MIMO layers.

Although FIG. 5 illustrates one example of BWP switching MIMO layers adaptation 500, various changes may be made to FIG. 5. For example, the number of BWPs may vary, the MIMO layer configuration may vary, etc. according to particular needs.

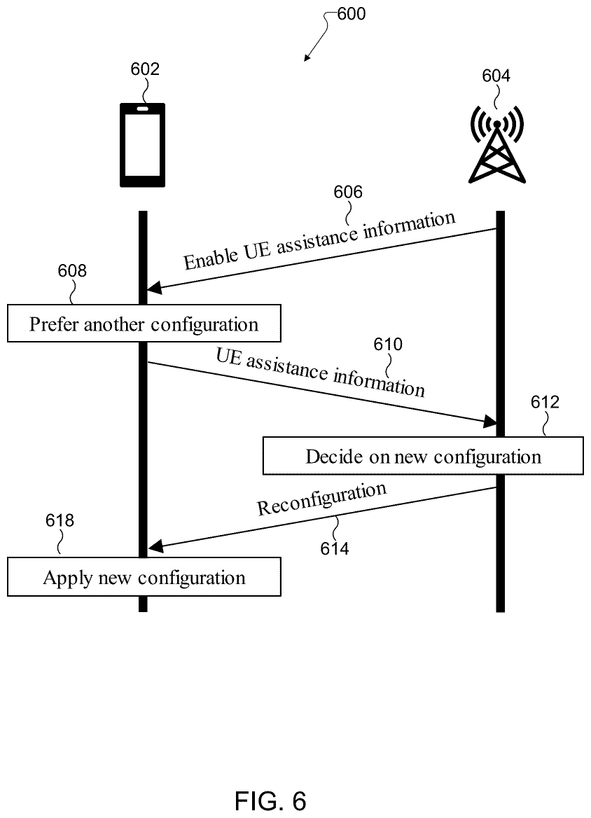

By utilizing the UE assistance information (UAI) framework introduced in Release 16, a UE can influence its own configuration by informing the NW about the UE's configuration preferences as illustrated in FIG. 6. For example, UAI messages can be sent for indicating preferred RF parameters for saving power, reducing overheating, and indicating preferred RRC state among others.

FIG. 6 illustrates an example UAI framework 600 according to embodiments of the present disclosure. An embodiment of the UAI framework illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a UAI framework may be used without departing from the scope of this disclosure.

As illustrated in FIG. 6, a UAI operation is performed between a UE 602 and a BS 604. The operation of UAI framework 600 begins at step 606. At step 606, BS 604 transmits a message enabling UE assistance information from UE602. At step 608, UE 602 determines that a different configuration from the present configuration of UE 602 is preferred. At step 610, UE 602 transmits UE assistance information to BS 604. At step 612, BS 604 determines a new configuration for UE 602 based on the UE assistance information received in step 610. At step 614, BS 604 transmits the new configuration to UE 602. Finally, at step 618, UE 602 applies the new configuration received in step 614.

Although FIG. 6 illustrates one example UAI framework 600, various changes may be made to FIG. 6. For example, while shown as a series of steps, various steps in FIG. 6 could overlap, occur in parallel, occur in a different order, or occur any number of times.

The packet delay budget (PDB) requirements for various services are described in the 3GPP standard. A subset of these requirements is provided in Table 2. Specifically, the delay budget of Table 1 is defined in terms of the 98^{th} percentile. That is to say, for guaranteed bit rate (GBR) applications, 98 percent of all the packets shall not experience a delay exceeding the PDB, whereas, for non-guaranteed bit rate (NGBR) applications, the 98^{th} percentile requirement applies to uncongested scenarios. In addition to the PDB, a fixed core network (CN) PDB is also defined. The access network (AN)-PDB can then be obtained as the difference between the PDB and the CN-PDB. The AN-PDB thus obtained, however, is relatively generous (see Table 1). To evaluate with relatively stringent requirements, 50% of the AN-PDB given by the 3GPP is assumed for evaluations described in the present disclosure. This stringent 5G-AN-PDB requirement used in the evaluations described herein is also given in Table 1. The same PDB is assumed for the UL and the DL packets.

TABLE 1
Latency requirements of several traffic classes as defined in the 3GPP standard.

| | | | | | 5G-AN PDB |
|---|---|---|---|---|---|
| | | | | | used in |
| | PDB | CN-PDB | GBR/ | 5G-AN PDB | evaluation |
| Example Services | (ms) | (ms) | NGBR | (ms) | (ms) |
| Conversational Voice | 100 | 20 | GBR | 80 | 40 |
| Conversational Video (Live | 150 | 20 | GBR | 130 | 65 |
| Streaming) | | | | | |
| Real-Time Gaming | 50 | 20 | GBR | 30 | 15 |
| Non-Conversational Video (Buffered | 300 | 20 | GBR | 280 | 140 |
| Streaming) | | | | | |
| Video (Buffered Streaming) | 300 | 20 | NGBR | 280 | 140 |
| TCP-based (e.g., www, e-mail, chat, | | | | | |
| ftp, p2p file sharing, progressive video, | | | | | |
| etc.) | | | | | |
| Voice, Video (Live Streaming), | 100 | 20 | NGBR | 80 | 40 |
| Interactive Gaming | | | | | |

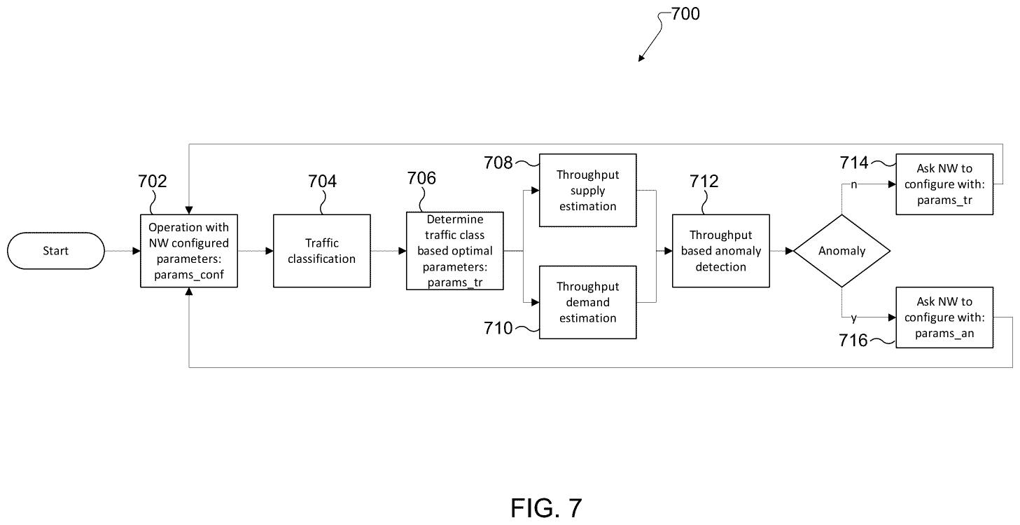

FIG. 7 illustrates an example procedure 700 for throughput prediction and anomaly detection for 5G UE power saving according to embodiments of the present disclosure. An embodiment of the procedure for throughput prediction and anomaly detection illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for throughput prediction and anomaly detection may be used without departing from the scope of this disclosure.

In the example of FIG. 7, procedure 700 begins at block 702. At block 702 a UE starts operation with NW configured parameters. The NW configured parameters are RF parameters, such as UL and DL MIMO layers, UL and DL BW, connected mode discontinuous reception (CDRX) inactivity timer and the cycle, the maximum number of component carriers etc. In the example of FIG. 7, the set of configured RF parameters is referred to as params_conf. At block 704, the UE performs a traffic classification operation. In one embodiment, the UE performs the traffic classification via a traffic classification module. The traffic classification module classifies the current traffic into one of multiple categories such as real-time (RT), non-real-time (NRT), and background etc. The traffic classification module may consider both IP packet history and PHY layer metrics to determine the application(s) that are running on the device. Different applications can be broadly categorized into RT and NRT traffic. For example, streaming (e.g., YouTube, Netflix, Prime video, etc.), browsing (e.g., browsing in an app or on web browser), etc., may be categorized as NRT traffic. Audio calls (e.g., WhatsApp, Messenger, Viber, etc.), video calls (e.g., WhatsApp, Messenger, MS Teams, etc.), online low-bit rate gaming (e.g., Among Us), and online high-bit rate gaming (e.g., PUBG, Call of duty, etc.) may be categorized as RT traffic.

The application classes can also be subclassified to have more than two classes. For example, the application classes can be subclassified into the following four classes: (i) real time low throughout, (ii) real time high throughput, (iii) non-real time low throughput, and (iv) non-real time high throughput. In one embodiment, the traffic classification module takes IP packet history over a specified time window (also referred to herein as a time step) as input and predicts the applications that may be running at the UE. The traffic classification module may consider features such as packet inter-arrival time, packet size, flow type, number of active flows, traffic class of each flow, etc., to determine the application. Further, the 3GPP specified 5QI values associated with the packet data unit (PDU) session may also indicate the traffic class. In one embodiment the traffic classification module may output the predicted traffic class, or the probabilities of each class. In one embodiment, The traffic classification module may be implemented using machine learning (ML) algorithms like XGBoost or convolutional neural networks (CNN) etc. In one embodiment, The traffic classification module can be implemented based on all the IP traffic, i.e., all packets, or based on the flows, i.e., separate classification for each five-tuple (source IP address/port number, destination IP address/port number and the protocol in use, i.e., transmission control protocol (TCP)/user datagram protocol (UDP) etc). The additional information along with inference from IP packet history may result in more accurate detection of the service type. The traffic classification module may be comprised by an application processor and may communicate with a communication processor to obtain necessary information, e.g., information about the PHY layer metrics.

At block 706, optimal RF parameters are determined for traffic class of the traffic classified in the traffic classification operation of block 704. These optimal RF parameters can result in power savings at the UE, without compromising the quality of service (QOS) of the currently active traffic class. In the example of FIG. 7, the set of optimal RF parameters based on traffic class are referred to as params_tr. The optimal RF parameters may be stored in the form of a look up table. In one embodiment, during online operation, the UE uses the look up the table to find the optimal parameters. In one embodiment, the lookup table is constructed offline. For example, the optimal RF parameters may be found experimentally. In one embodiment, finding the optimal parameters comprises conducting an exhaustive search over all the RF parameter combinations of interest. In the search parameters are identified that are likely to result in reduced power consumption. These parameters are stored in a Table that the UE uses during online operation.

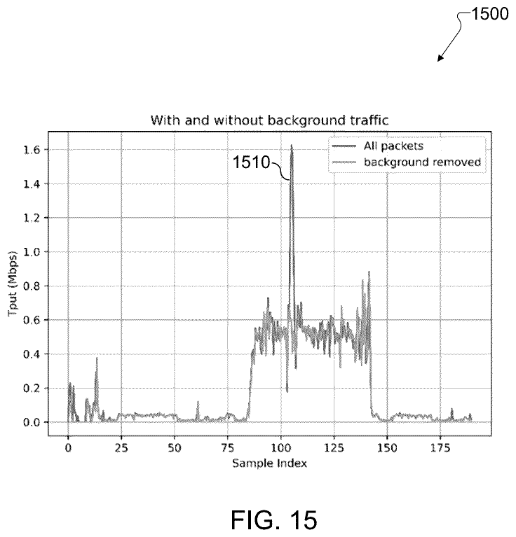

Under normal circumstance, the parmas_tr should be able to meet the throughput requirement of the active traffic class. This is because these parameters are chosen specifically for a traffic class to meet QoS requirements. There, however, can be instances when params_tr do not meet the requirement of the currently active traffic class. One example is erroneous detection by the traffic classification module. Generally, the traffic classification module is expected to have high accuracy, i.e., >95%, and as such the probability of erroneous detection is low. It is, however, the low probability that raises the problem of an anomalous traffic condition (also referred to herein as an anomaly)—that is, an event that is not commonly experienced or expected. If the traffic classification module makes an erroneous decision, then the params_tr will be based on the output of the traffic classification module, and the parameters may not meet the throughput requirement of the ground truth traffic class. Another example where params_tr may not meet the requirement of the currently active traffic class is sudden and unexpected increase in the throughput. As an example, this increase in the throughput can be from the background traffic as illustrated in FIG. 15. In some instances, this increase can also be due to the currently active application of interest e.g., for processes that are necessary for the smooth running of the application but may not be directly related to the user QoS. An example of this could be that during a video call necessary sporadic communication or information exchange with the host server may happen that is not directly the video content transfer. In one embodiment, to detect and recover from such anomalies, a throughput supply (block 708) and demand (block 710) estimation is performed.

In one embodiment, throughput supply estimation refers to a process of estimating the throughput that the UE can expect to achieve, e.g., with current RF parameters, channel conditions, and NW load etc. In one embodiment, throughput demand estimation refers to a process of estimating the throughput requirement of the currently active applications. At block 712, these two throughputs are compared to detect if there is some anomalous. Specifically, with everything running as expected, i.e., suitable RF parameter selection, it is not expected for the demand to exceed the supply. In this circumstance, the procedure proceeds at block 714, and the UE asks the NW to configure the UE with params_tr. If, however, there is some detection of anomalous behavior, it is desirable to operate with RF parameters that can meet the demand. In this circumstance, the procedure proceeds to block 716, and the UE asks the NW to configure the UE with RF parameters that can meet the demand. In the example of FIG. 7, these parameters are referred to as params_an. These parameters would typically increase the throughput supply compared to e.g., params_conf and/or params_tr, to recover from the anomalous situation.

Although FIG. 7 illustrates one example procedure 700 for throughput prediction and anomaly detection for 5G UE power saving, various changes may be made to FIG. 7. For example, while shown as a series of steps, various steps in FIG. 7 could overlap, occur in parallel, occur in a different order, or occur any number of times.

As described herein (e.g., with respect to block 708 of FIG. 7), a UE may perform a throughput supply estimation as part of a throughput prediction and anomaly detection procedure. In 5G NR, the NW throughput (referred to herein as throughput supply) for one component carrier can be given as

$${Tput}_{s} = L \times Q \times R \times ( {N}_{PRB} > 12 ) \div {T}_{s} \times ( 1 - OH ) ,$$

where L is the number of layers (e.g., 2), Q is the modulation order (e.g., 8), R is the code rate (e.g., 948/1024), N_{PRB} are the number of physical resource blocks (PRBs) (e.g., 12), Tₛ is the OFDM symbol period (e.g., 66 μs), and OH represents the overhead-including pilot transmission and other signaling overhead (e.g., 0.14 for DL in sub-6 GHz). The throughput from multiple component carriers can be summed to get the overall throughput.

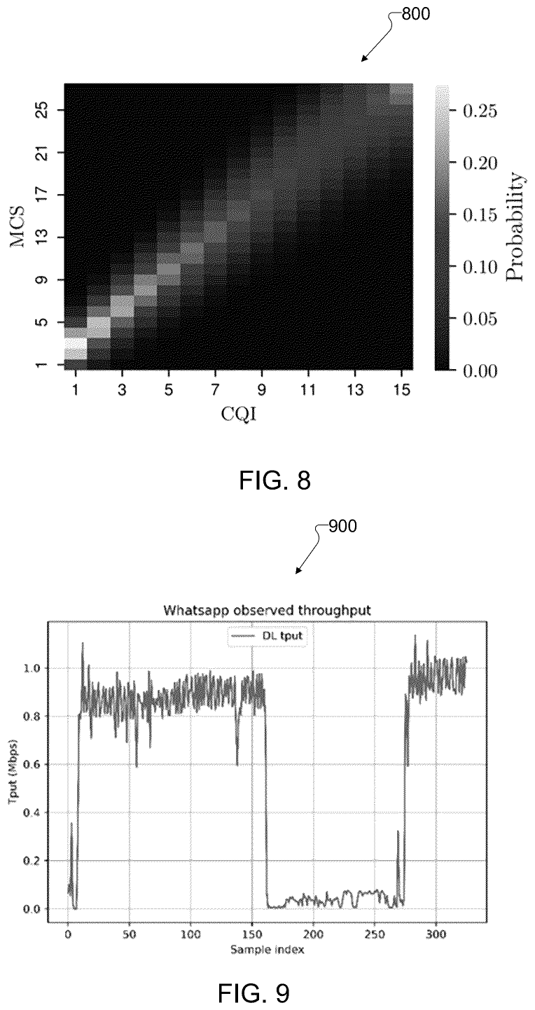

Note that the parameter N_{PRB} is a deterministic function of the operating BW that the UE knows. The parameter Tₛ is also a deterministic function of the numerology which the UE also knows. Estimates for the term OH are provided by 3GPP for different types of operations, e.g., sub-6 GHz and mmWave and can be used in the formula. Further, both the modulation order Q and the coding rate R can be obtained from modulation and coding scheme (MCS) tables provided by 3GPP. In one embodiment, the aforementioned pieces of information are available at a communication processor of the UE for cellular communication purposes, and can be shared with an application processor where throughput supply estimation may be performed. The NW makes the determination of MCS based on feedback provided by the UE using channel quality indicator (CQI). Since CQI is available at the UE, CQI to MCS mapping can be used to get an estimated MCS and subsequently estimated Q and R. In one embodiment, the CQI to MCS table provided by 3GPP is used as is to estimate the throughput. In another embodiment, the UE uses past observations of MCS for a given CQI to estimate the throughput. In one embodiment, a variety of MCS allocations are made for a single CQI. In such and embodiment, the UE can develop a probability distribution for MCS given a CQI, and average over the probability distribution to estimate throughput supply. An example MCS probability distribution is shown in FIG. 8.

FIG. 8 illustrates an example probability distribution 800 of MCS given CQI according to various embodiments of this disclosure. The embodiment of probability distribution 800 in FIG. 8 is for illustration only. Other embodiments of a probability distribution of MCS given CQI could be used without departing from the scope of this disclosure.

In the example of FIG. 8, the probability of a particular MCS being configured for the UE based on a particular CQI is graphed. For example, it can be seen in FIG. 8 that if the CQI is 7, there is approximately a 0.15 probability that the MCS will be 13. Based on this and other parameters previously discussed, the UE can calculate a throughput supply prediction.

Although FIG. 8 illustrates one example probability distribution 800 of MCS given CQI, various changes may be made to FIG. 8. For example, the probabilities may vary, the CQI may vary, the MCS may vary, etc. according to particular needs.

Note that the number of layers is a function of maximum MIMO layers and the channel through rank indicator (RI). In one embodiment, the UE uses the minimum between the configured MIMO layers and RI+1 (addition of 1, since RI starts from 0) to get L to be used in throughput supply calculations. In another embodiment, the UE uses the past observations of the allocated layers for a given RI. In such an embodiment, a probability distribution for layers is formed for a given RI, and the UE averages over that probability distribution followed by a rounding operation to get L. Note that the aforementioned throughput supply estimation equation does not take into consideration the NW load, or other scheduling behavior of the NW. In one embodiment, the UE estimates the NW load, e.g., by looking at signal quality metrics like signal to interference plus noise ratio (SINR) and uses that to scale the throughput. This scaling can be based on changing the N_{PRB} to N′_{PRB}, where N_{PRB} is the estimate of the number of PRBs available to be the UE in a loaded cell. Different NW schedulers could also apply different resource allocation behaviors, e.g., capping the resource for one user while using a certain application, e.g., streaming at a high resolution, or doing repeated speed tests. In one embodiment, the UE maintains a record of, e.g., 80^{th} percentile, of PRB allocation for a given application in the recent past (e.g., last 5 seconds)—say N″_{PRB}— and use N″_{PRB} to estimate the throughput supply.

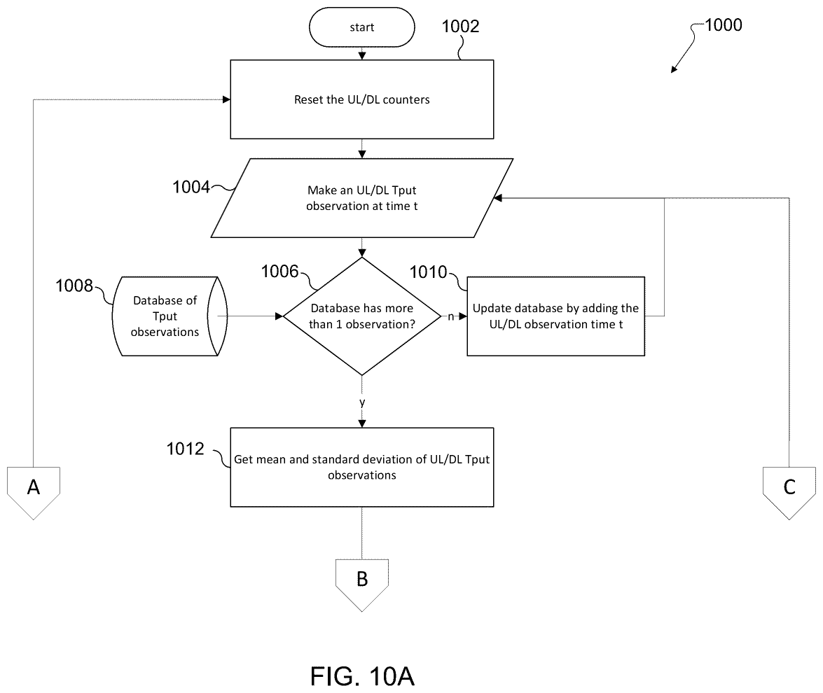

As described herein (e.g., with respect to block 710 of FIG. 7), a UE may perform a throughput demand estimation as part of a throughput prediction and anomaly detection procedure. In one embodiment, the throughput demand estimation is performed via a throughput demand estimation module. In one embodiment, the throughput demand prediction module tracks the current and past throughput consumption of the UE and predicts the future throughput. According to best practices, the throughput prediction module should predict sudden changes in throughput. An example of a sudden change in throughput is illustrated in FIG. 9.

FIG. 9 illustrates an example 900 of sudden changes in throughput according to various embodiments of this disclosure. The embodiment of sudden changes in throughput in FIG. 9 is for illustration only. Other embodiments of sudden changes in throughput could be used without departing from the scope of this disclosure.

In the example of FIG. 9, sudden changes in throughput are depicted for one observed trace of the application WhatsApp. It can be seen om FIG. 9 that throughput between sample index 170 to 270 is low and suddenly reaches the 0.9-1 mbps level at the sample index ˜275.

Although FIG. 9 illustrates one example 900 of sudden changes in throughput, various changes may be made to FIG. 9. For example, the app may vary, the throughput may vary, the sample index may vary, etc. according to particular needs.

One objective of the throughput prediction module is to track these sudden changes well. If the throughput is predicted based on past observation, it can be argued that observations before sample index 270 of FIG. 9 are not useful in predicting the throughput after sample index 275. If, however, we were predicting the throughput at sample index 150, the observations from samples 50-150 can be useful. Based on this observation, the development and maintenance of a database of past throughput observations for throughput prediction is desirable. In one embodiment, a throughput observation database is updated/maintained to contain the most relevant throughput observations.

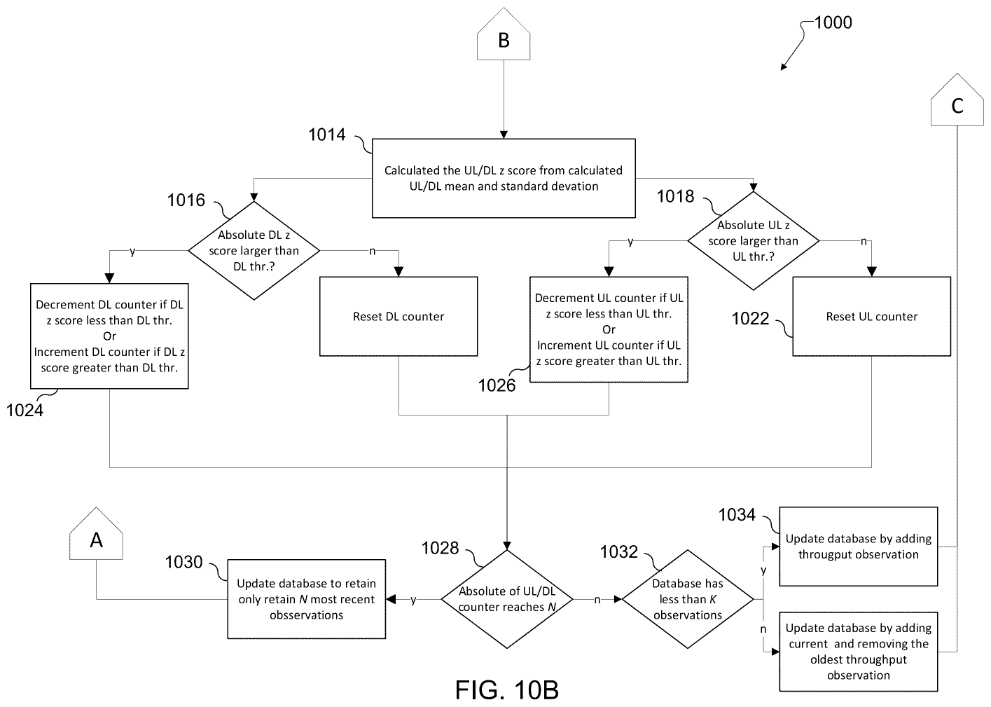

FIGS. 10A-10B illustrate an example procedure 1000 for database maintenance for throughput demand estimation according to embodiments of the present disclosure. An embodiment of the procedure for database maintenance illustrated in FIGS. 10A-10B is for illustration only. One or more of the components illustrated in FIGS. 10A-10B may be implemented in specialized circuitry configured to perform the noted functions or one or more of the components may be implemented by one or more processors executing instructions to perform the noted functions. Other embodiments of a procedure for database maintenance for throughput demand estimation may be used without departing from the scope of this disclosure.

In the example of FIGS. 10A-10B, the procedure may be summarized as checking whether new throughput observations deviate significantly from previous observations by performing a z-test. If new observations deviate significantly from previous observations a few observations, the database is reset. Procedure 1000 begins at block 1002. At block 1002, throughput observation counters (i.e., UL throughput and DL throughput counters) are initialized to 0. These counters are used to check if the throughput observations are deviating from the past observations a specific number of times. At block 1004, a UL and DL throughput observation is made at time t. In the example of FIGS. 10A-10B, a throughput observation is made every T seconds. The T second observation may be referred to herein as a time step. At block 1006, after every observation, a check is performed whether the size of the database 1008 is larger than one. This is because block 1012 checks the standard deviation of the measurements, and standard deviation can only be calculated meaningfully for at least two observations. If there are not two observations yet, the procedure continues at block 1010 where database 1008 is updated and procedure 1000 then repeats. If, however, there are two or more observations, at block 1012, the mean and standard deviation of the observations in database 1008 are calculated. Subsequently, at block 1014, the z score of the current throughput observation is calculated based on the mean and standard deviation (e.g., a statistical analysis) of the past throughput observations calculated at block 1012. Note that in the z-test a constant epsilon is introduced in the denominator. This is to avoid division by 0 when the standard deviation is 0, which can happen particularly when the database contains only a few entries. The absolute z score is then compared to a threshold for the UL (block 1016) and DL (block 1018) z scores. A threshold for both the DL z score and the UL z score controls how far the current throughput observation should be from the mean of prior inputs to be considered different. A typical value is 2, which indicates that an observation 2 standard deviations away from the mean will be considered different. If the new observation is not different form past observations the DL (block 1020) and/or UL counter (block 1022) is reset. If, however, the observation is different, the DL (block 1024) and/or UL (block 1026) counter is updated based on the direction of the change. If the value of the new observations is substantially smaller than the prior observations, then the appropriate counter is decremented. If the value of the new observations is substantially larger than the prior observations, then we appropriate counter is incremented. The benefit of updating the counter based on the direction of change is that two consecutive changes in opposite directions are cancelled out with respect to the counter, as they do not indicate a true change in the throughput. Instead, changes in opposite direction indicate rather a higher variation. At block 1028, the absolute value of the counters are compared to a predetermined value N. The value N indicates, how may observations should deviate from the mean before it is considered that the throughput has substantially changed. If either the DL or the UL counter reaches N, the procedure proceeds to block 1030 and database 1008 is updated to only retain the most recent N observations, since these N observations represent the new statistic of the throughput. The counters are then reset at block 1002. If, however, the absolute value of either the DL or UL counter has not reached N, database 1008 is updated with the new throughput observation beginning at block 1032. The database maintenance procedure 1000 only considers the K past values. The value of K is chosen to (i) ensure K is large enough so that sufficient observations are included in the database to obtain a good estimate of mean and standard deviation of the throughput, and (ii) K is small enough that outdated observations that are no longer relevant for the current throughput estimation are not included in the database. At block 1032, if the size of database 1008 is less than K, the procedure proceeds at block 1034 and the most recent throughput observation is added to database 1008. If, however, the size of database 1008 is K, the procedure proceeds at block 1036 the oldest observation is removed from database 1008 before the newest observation is added.

In another embodiment, only the UL throughput observations are removed from the database if the z-score condition is met on the UL, and only the DL throughput observations are removed from the database if the z-score condition is met on the DL. In this manner, the database retains the observations for UL (or DL) if substantial deviation is not detected on UL (or DL), which aids with accurate mean and standard deviation estimation.

In another embodiment, a modified z-score is used instead of the z-score. This is suitable when the number of observations is small, and the throughput data is substantially different from a normal distribution.

In yet another embodiment, the size of database 1008 is not limited to K, and all observations are included in database 1008 as long as the database is not reset due to finding outliers. This permits accurate estimation of mean and standard deviation, but may not reflect a good mean estimation in cases where the throughput increases of decreases slowly over a long time period.

Although FIGS. 10A-10B illustrate one example procedure 1000 for database maintenance for throughput demand estimation, various changes may be made to FIGS. 10A-10B. For example, while shown as a series of steps, various steps in FIGS. 10A-10B could overlap, occur in parallel, occur in a different order, or occur any number of times.

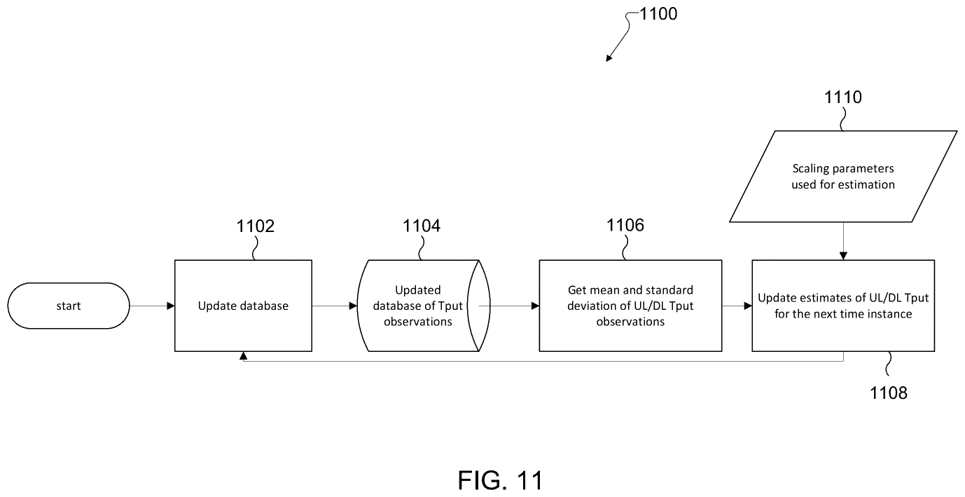

In one embodiment the throughput demand (e.g., with respect to block 710 of FIG. 7) is calculated from the observations retained in the database (e.g., database 1008 of FIG. 10A). For example, in one embodiment, the throughput demand is based on the mean and standard deviation of the observations as illustrated in FIG. 11.

FIG. 11 illustrates an example procedure 1100 for throughput demand prediction using mean and standard deviation. An embodiment of the procedure for throughput demand prediction illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for throughput demand prediction using mean and standard deviation may be used without departing from the scope of this disclosure.

In the example of FIG. 11, procedure 1100 begins a block 1102. At block 1102, a database 1104 of throughput observations is updated with the most recent throughput observation. At block 1106, the mean and standard deviation of the UL and DL throughput observations from database 1104 are calculated. Then at block 1108, a new estimate of throughput demand is calculated based on the mean and the standard deviations calculated in block 1106. In one embodiment, the demand is estimated by scaling the standard deviation and adding to the mean using scaling parameters 1110. Scaling is performed because, as an example, when the throughput demand is quite stable and does not vary quite a lot, then predicting demand to be closer to the mean is acceptable. Similarly, when the demand varies quite a lot, then predicting close to mean will ignore the high momentary throughput peaks. Including standard deviation in the demand prediction provides a natural way to incorporate variation in the demand estimate. The scaling parameters 1110 for the UL/DL throughput estimate control how much the variation impacts the demand estimate. Example values of these parameters range from 1-2.

Although FIG. 11 illustrates one example procedure 1100 for throughput demand prediction using mean and standard deviation, various changes may be made to FIG. 11. For example, while shown as a series of steps, various steps in FIG. 11 could overlap, occur in parallel, occur in a different order, or occur any number of times.

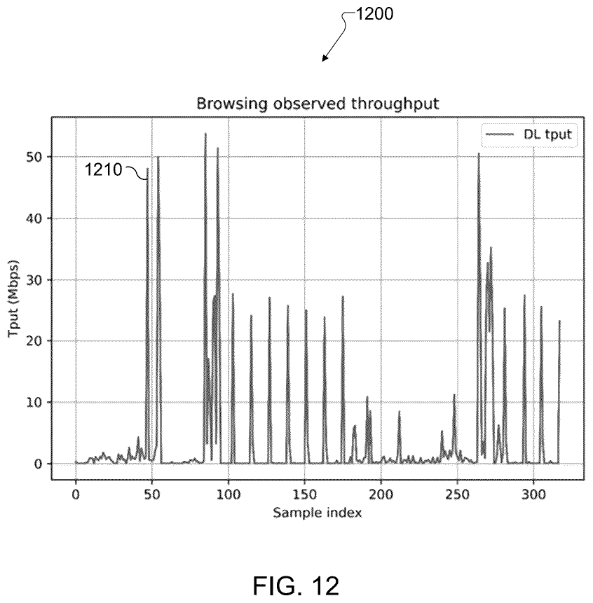

In another embodiment, the throughput demand is estimated based on a specific percentile value in the database. Such and embodiment, in comparison with mean and standard deviation-based approach can achieve a more targeted behavior. To elaborate, consider the trace for browsing activity as shown in FIG. 12.

FIG. 12 illustrates an example 1200 of a browsing throughput trace according to various embodiments of this disclosure. The embodiment of a throughput trace FIG. 12 is for illustration only. Other embodiments of a throughput trace could be used without departing from the scope of this disclosure.

In the example of FIG. 12, the peaks in the throughput (e.g., peak 1210) indicate the regions where a webpage is being loaded.

Although FIG. 12 illustrates one example 1200 of a browsing throughput trace, various changes may be made to FIG. 12. For example, the app may vary, the throughput may vary, the sample index may vary, etc. according to particular needs.

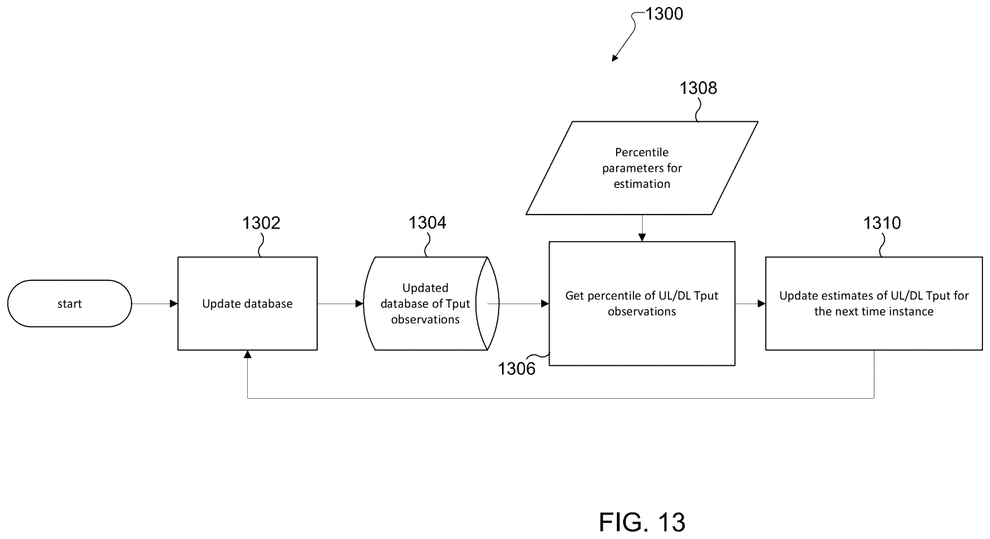

To ensure that the user behavior is not interrupted e.g., by the webpage loading behavior illustrated in FIG. 12, the throughput at the peaks become important to track rather than the mean value, even if augmented by standard-deviation. A percentile-based throughput demand method similar as illustrated in FIG. 13 allows a way to directly account for this issue.

FIG. 13 illustrates an example procedure 1300 for throughput demand prediction using percentiles. An embodiment of the procedure for throughput demand prediction illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a procedure for throughput demand prediction using percentiles may be used without departing from the scope of this disclosure.

In the example of FIG. 13, procedure 1300 begins a block 1302. At block 1302, a database 1304 of throughput observations is updated with the most recent throughput observation. At block 1306, a percentile of the UL and DL throughput observations in database 1304 are obtained based on percentile parameters 1308. As an example, if the percentile parameter value is set to 99^{th} percentile, it will easily track the peak throughput. In the case of applications with relatively consistent throughput for longer periods of time (such as the WhatsApp trace of FIG. 9), such an approach would still result in a value that is only slightly above the mean. Further fine-tuning the percentile values based on the traffic type can improve results, e.g., 70^{th} percentile may be used for consistent traffic patterns, whereas 99^{th} percentile may be used for bursty traffic patterns. At block 1310, a new estimate of throughput demand is calculated based on the percentiles obtained in block 1306.

Although FIG. 13 illustrates one example procedure 1300 for throughput demand prediction using percentiles, various changes may be made to FIG. 13. For example, while shown as a series of steps, various steps in FIG. 13 could overlap, occur in parallel, occur in a different order, or occur any number of times.

As previously described herein, throughput prediction may be implemented using a database similar as described in FIGS. 10A-10B (i.e., database 1008). In one embodiment, database stores the throughput observations at every time step t. These throughput observations can be made at the physical (PHY) layer. As a result, the entirely of the database maintenance module and throughput prediction module may be implemented using the throughput observations made at the PHY layer. Note that, in 5G NR, the UE obtains the transport block size (TBS) in every slot. The procedure for obtaining the transport block size is standard.

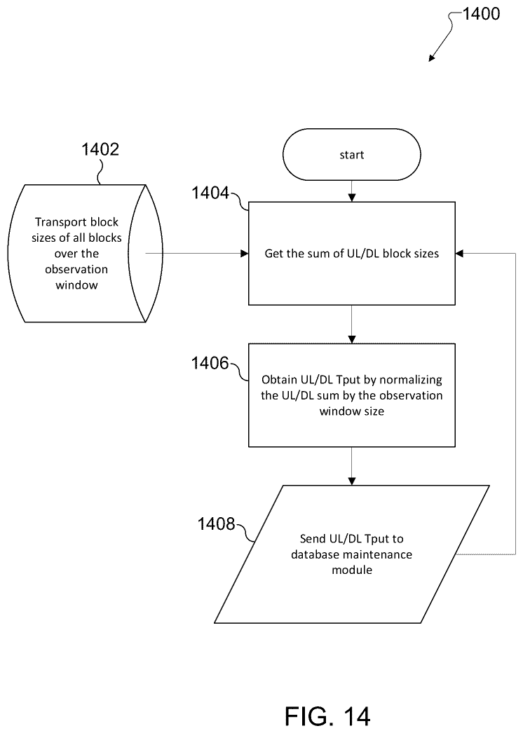

FIG. 14 illustrates an example procedure 1400 for throughput observations at the PHY layer. An embodiment of the procedure for throughput observation of FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a procedure for throughput d observations at the PHY layer may be used without departing from the scope of this disclosure.

In the example of FIG. 14, to get the throughput estimate, at block 1402 the UE retains the TBS for all the transport blocks in the last T seconds, i.e., the time step or observation window. At block 1404, the UE then sums the TBSs to get the total PHY layer data. At block 1406, this sum is then divided by the time step or observation window to get the throughput observation in bps. This results in a normalized total of the TBSs. This throughput observation is then shared with the database maintenance module (e.g., procedure 1000) at block 1408. The main benefit of using throughput observations at the PHY layer is that all of the signaling overhead is included in the throughput demand calculation, and throughput supply can be directly compared with the supply. This is because the TBS calculation itself considers the signaling overhead and redundancy, i.e., coding rate etc. These are the same factors that are considered for the supply calculation (through terms R and OH).

Although FIG. 14 illustrates one example procedure 1400 for throughput observations at the PHY layer, various changes may be made to FIG. 14. For example, while shown as a series of steps, various steps in FIG. 14 could overlap, occur in parallel, occur in a different order, or occur any number of times.

Throughput observations can also be made at the IP packet level. The benefit of this strategy is that some background traffic can be separated and not considered in throughput demand prediction. To illustrate the importance of background separation, consider the example traces in FIG. 15.

FIG. 15 illustrates an example 1500 of a trace of traffic with and without background traffic according to various embodiments of this disclosure. The embodiment of a throughput trace FIG. 15 is for illustration only. Other embodiments of a trace of traffic with and without background traffic could be used without departing from the scope of this disclosure.

In the example of FIG. 15, there is a peak in the traffic 1510, when all packets are considered, that can be removed excluding the background traffic. In the example of FIG. 15, background traffic refers to all the packets that come from five tuples (TCP/IP protocol, source IP, destination IP, source port, and destination port) that do not have an associated process ID (PID). The process ID is an identifier indicating the flow belongs to a particular process (e.g., WhatsApp). The trace of FIG. 15 demonstrates that some false peaks in the demand, which are peaks that do not come from the actual active application, can be avoided by ignoring the background traffic.

Although FIG. 15 illustrates one example 1500 of a trace of traffic with and without background traffic, various changes may be made to FIG. 15. For example, the app may vary, the throughput may vary, the sample index may vary, etc. according to particular needs.

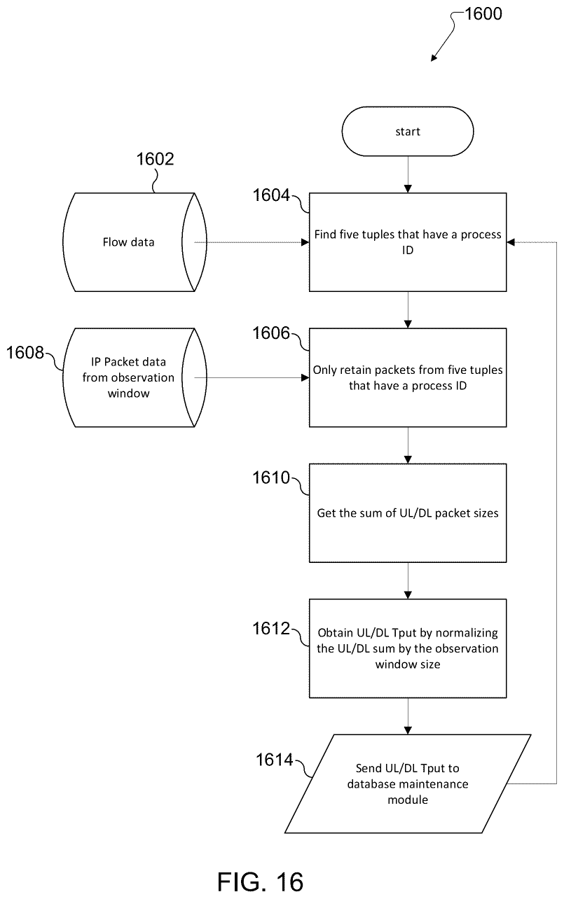

FIG. 16 illustrates an example procedure 1600 for obtaining packet based throughput observations ignoring the background traffic. An embodiment of the procedure for obtaining packet based throughput observations of FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of a procedure for obtaining packet based throughput observations ignoring the background traffic may be used without departing from the scope of this disclosure.

In the example of FIG. 16, a flow database 1602 is maintained. Flow database 1602 contains information about all the active flows (i.e., five tuples) and the corresponding PIDs. Multiple flows can correspond to the same PID. The information about flows and the PIDs can be obtained, as an example, from the netstat tool. At block 1604, two sets of five tuples are created from the flow data. First is the set 5tuples, that contains all the 5tuples. Second, is the set 5tuples_no_PID, which contains all the 5tuples without any corresponding PIDs. Subsequently, at block 1606, the set of all five tuples that have some PID can be obtained as the set difference between the two sets, i.e., 5tuples\5tuples_no_PID. Furthermore, at block 1606, packet level data 1608 is obtained, i.e., the time, direction (UL/DL), and size of all the packets. At block 1610, for all the packets corresponding to five tuples in the difference set 5tuples\5tuples_no_PID, sizes of all the packets in UL (DL) are summed to get sum_UL (sum_DL). At block 1612, this sum is then divided by the sampling interval T—or window size—to get the Tput. This results in a normalized total of the packet sizes. At block 1614, This Tput is then shared with the database maintenance module (e.g., procedure 1000).

Although FIG. 16 illustrates one example procedure 1600 for obtaining packet based throughput observations ignoring the background traffic, various changes may be made to FIG. 16. For example, while shown as a series of steps, various steps in FIG. 16 could overlap, occur in parallel, occur in a different order, or occur any number of times.

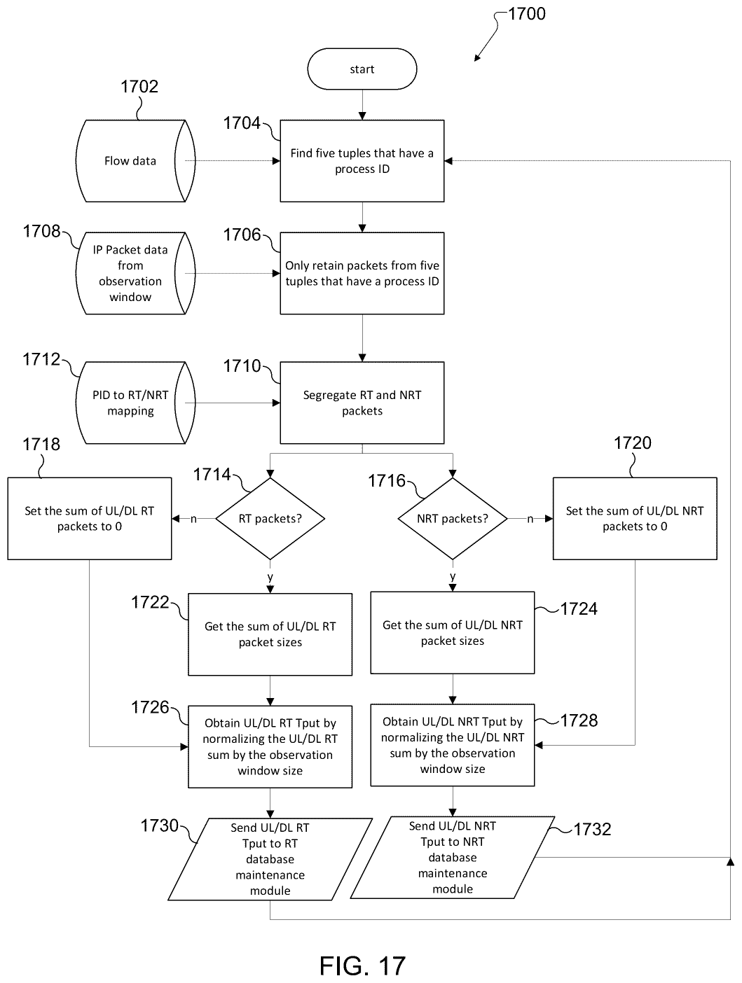

In another embodiment, the throughput observations, database maintenance, and throughput predictions are made separately for the RT and NRT traffic. The separate RT and NRT throughput predictions are then combined to produce a single throughput prediction. The rationale for separating the observation, database maintenance and throughput prediction for RT and NRT is that the hyper-parameters of the throughput prediction module can be tuned separately for RT and NRT traffic. As an example, consider the percentile-based throughput procedure of FIG. 13. For the NRT bursty traffic, the demand may be accurately represented by peaks and hence the percentile parameter should be set close to 100, e.g., 99. On the other hand, for RT consistent traffic momentary peaks-if any-should be ignored and the percentile parameters should be set, e.g., in the 50-70 range. As such, if both the RT and NRT traffic is being produced/consumed at the same time, two modules, dedicated for predicting throughput demand separately for RT/NRT can be provided as illustrated in FIG. 17.

FIG. 17 illustrates an example procedure 1700 for obtaining packet based throughput observations separately for RT and NRT traffic. An embodiment of the procedure for obtaining packet based throughput observations of FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of a procedure for obtaining packet based throughput observations separately for RT and NRT traffic may be used without departing from the scope of this disclosure.

In the example of FIG. 17, blocks 1702-1708 remove the background traffic similar as described regarding FIG. 16. A flow database 1702 is maintained. Flow database 1702 contains information about all the active flows (i.e., five tuples) and the corresponding PIDs. Multiple flows can correspond to the same PID. The information about flows and the PIDs can be obtained, as an example, from the netstat tool. At block 1704, two sets of five tuples are created from the flow data. First is the set 5tuples, that contains all the 5tuples. Second, is the set 5tuples_no_PID, which contains all the 5tuples without any corresponding PIDs. Subsequently, at block 1706, the set of all five tuples that have some PID can be obtained as the set difference between the two sets, i.e., 5tuples\5tuples_no_PID. Furthermore, at block 1706, packet level data 1708 is obtained, i.e., the time, direction (UL/DL), and size of all the packets. At block 1710, the packets are segregated into RT and NRT packets. This segregation comprises PID to RT/NRT mapping 1712. In one embodiment, the UE performs mapping 1712 with the assistance of the traffic classification module to get RT/NRT predictions and the flow data. In another embodiment, mapping 1712 is jointly maintained by multiple UEs and shared among UEs to be kept updated. A check is performed whether there are RT (block 1714) and NRT (block 1716) packets. If there are no RT (block 1718) or NRT (block 1720) the sum of the respective packet sizes is set to 0. If there are RT (block 1722) or NRT (block 1724), packets, then the sum is set to the sum of all packets observed for the respective packet type. These sums are converted to Tput by dividing with the step size T or observation window size (blocks 1726, 1728). Finally, at block 1730 the throughput observations for the RT traffic are shared with a RT traffic database maintenance module, and at block 1732 the throughput observations for the NRT traffic are shared with a NRT database maintenance module. The throughput prediction modules following the RT database and NRT database have hyper parameters suitable for RT and NRT, respectively. Finally, the combining of the Tput from the RT Tput demand prediction module and the NRT Tput demand prediction module can simply be the summation of the two individual throughputs.

Although FIG. 17 illustrates one example procedure 1700 for obtaining packet based throughput observations separately for RT and NRT traffic, various changes may be made to FIG. 16. For example, while shown as a series of steps, various steps in FIG. 16 could overlap, occur in parallel, occur in a different order, or occur any number of times.

Once the supply and the demand throughput are available, detecting a throughput anomaly can be a simple comparison between the two, barring a threshold. However, there are some timing related issues that should be accounted for. For example, a determination should be made for when to resume normal operations after an anomaly.

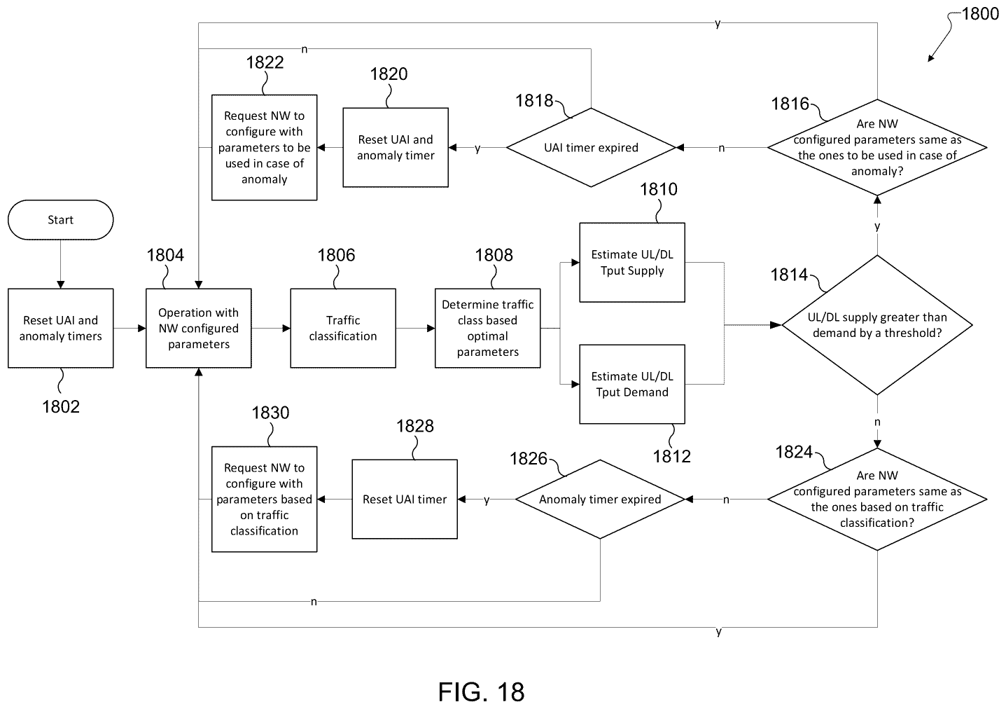

FIG. 18 illustrates an example method 1800 for throughput based anomaly detection and correction according to embodiments of the present disclosure. An embodiment of the method for throughput based anomaly detection and correction illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments of a method for throughput based anomaly detection and correction may be used without departing from the scope of this disclosure.

In the example of FIG. 18, the RF parameters that the UE operates with are set by the NW. As such, whenever a UE has a recommendation, the recommendation needs to be shared with NW so that the NW can configure the UE with the requested parameters. This is enabled by the UAI framework introduced in 3GPP release 16. The UE shares its preferred parameters no sooner than the UAI prohibit timer (e.g., 0.5 seconds). The example of FIG. 18 also includes an anomaly timer that controls the resumption of normal operation after anomaly detection. Method 1800 begins at block 1802. At block 1802 both the UAI and anomaly timers are set to 0. At block 1804, the UE starts operation with the NW configured parameters. These parameters are the currently configured parameters for the UE at any particular time. In the example of FIG. 18, the set of these parameters is referred to as params_conf. At block 1806, the UE performs a traffic classification operation. In one embodiment, the UE performs the traffic classification via a traffic classification module. At block 1808 the parameters suitable for the traffic type classified in block 1806 are determined. In the example of FIG. 18 these parameters referred to as params_tr. At block 1810, the throughput supply estimation module estimates the throughput supply. At block 1812, the demand module estimates the demand. At block 1814, if the demand exceeds the supply by a threshold in either the DL or UL, an anomaly is declared. The threshold leaves some margin for imperfections in the throughput supply and demand estimation. In one embodiment, with IP packets-based throughput observations, the demand is based on IP packets, whereas the supply is based on PHY. In such an embodiment, the threshold also models the overhead added to the IP packets before they are transmitted on PHY. If there is an anomaly, at block 1816, a check is performed to see if the current configured parameters, parmas_conf, are already the parameters that are to be used in the case of an anomaly, params_an. If this is the case, then no action is needed and operation with NW configured parameters continues at block 1804. If the parameters_conf are not the same as params_an, then at block 1818 a check is performed to see if the UAI timer has expired. If not, the operation with the NW configured parameters continues at block 1804. Otherwise, the UAI and anomaly timers are reset at block 1820, and params_an are shared with the NW to reconfigure the UE at block 1822. In one embodiment, the parameters declared to be used in an anomalous situation, params_an, are the default NW configured parameters. The default NW configured parameters are the parameters that the NW configures the UE within the beginning. In another embodiment, the parameters declared to be used in an anomalous situation, params_an, are found and set explicitly for the purpose of recovering from the anomalous situation as soon as possible. An example of these parameters is the largest possible BW, largest number of layers, smallest CDRX cycle, and inactivity timer equal to the CDRX cycle minus the CDRX on duration. If it is determined that there is no anomaly, then at block 1824 a check is performed to see whether the configured parameters are the same as the parameters determined based on the traffic. If these parameters are same, then no action is required, and operation can continue with NW configured parameters at block 1804. If not, at block 1826 a check is performed to see if the anomaly timer has expired. The role of the anomaly timer is avoid reconfiguring the UE too soon after detecting an anomaly. In the example of FIG. 18, the anomaly timer (e.g., 3 seconds) is expected to be larger than the UAI prohibit timer. Consider one example, in which the traffic classification is based on IP packets, and the IP packets are observed for a specific amount of time before a reliable output can be given. After the detection of the anomaly, the RF parameters will change, and the IP packet statistics may change. In this example, there should be some wait some time before any parameters set based on the output of the traffic classifier can be used. This is controlled by the anomaly timer. At block 1826, if the anomaly timer has expired, at block 1828 the UAI timer is reset and at block 1830 the UE requests the NW to reconfigure it with params_tr. Otherwise, operation with NW configured parameters continues at block 1804.

Although FIG. 18 illustrates one example method 1800 for throughput based anomaly detection and correction, various changes may be made to FIG. 18. For example, while shown as a series of steps, various steps in FIG. 18 could overlap, occur in parallel, occur in a different order, or occur any number of times.

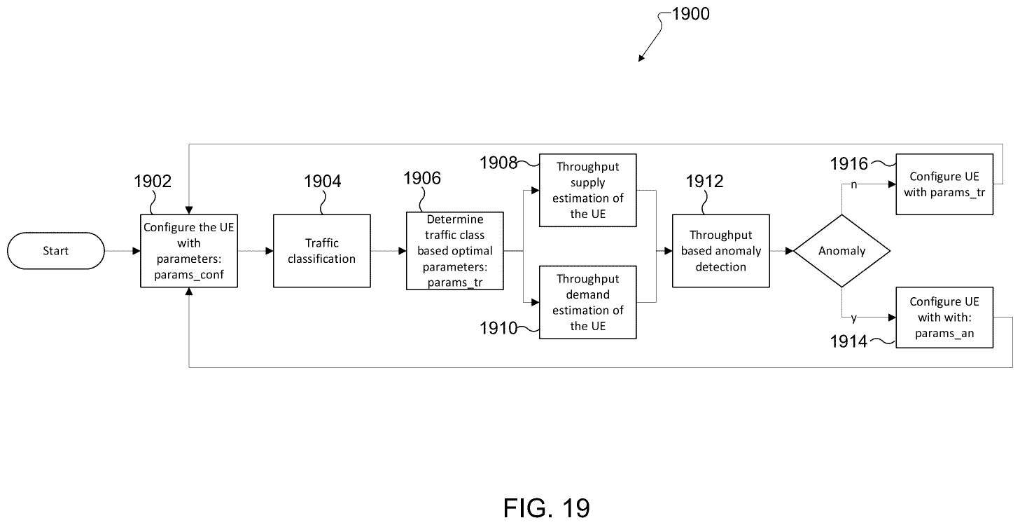

As previously described herein, determination of optimal network parameters for the UE occurs at the UE. However, a NW side device (e.g., a base station) may be configured to determine the optimal network parameters for the UE. An example of such an embodiment is illustrated in FIG. 19.

FIG. 19 illustrates an example procedure 1900 for throughput prediction and anomaly detection for 5G UE power saving at the NW according to embodiments of the present disclosure. An embodiment of the procedure for throughput prediction and anomaly detection illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of a procedure for throughput prediction and anomaly detection at the NW may be used without departing from the scope of this disclosure.

In the example of FIG. 19, procedure 1900 begins at block 1902. At block 1902, the NW configures a UE with some default parameters params_conf. The UE starts transmitting and receiving after applying these default parameters. At block 1904, the NW performs traffic classification on the UE's traffic. The traffic classification may be similar as previously described herein. At block 1906, based on the result of the traffic classification, the NW determines the parameters that the UE should be configured with to satisfy the demand of the determined traffic class. Subsequently, the NW performs the throughput supply estimation (block 1908) and the throughput demand estimation (block 1910). At block 1912, the NW determines whether an anomaly exists based on the throughput supply and demand. If an anomaly is detected, at block 1914 the NW configures the UE with the parameters that can help the UE recover from the anomaly, i.e., params_an. If no anomaly is detected, at block 1916 the NW configures with the parameters determined based on the traffic class, i.e., params_tr.

Although FIG. 19 illustrates one example procedure 1900 for throughput prediction and anomaly detection for 5G UE power saving at the NW, various changes may be made to FIG. 19. For example, while shown as a series of steps, various steps in FIG. 19 could overlap, occur in parallel, occur in a different order, or occur any number of times.

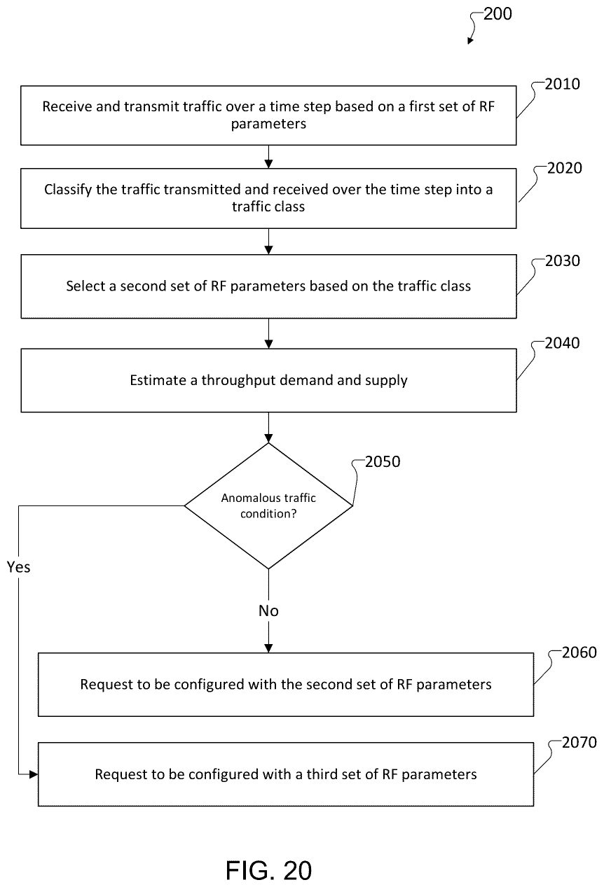

FIG. 20 illustrates a method 2000 for throughput prediction, anomaly detection, and correction for 5G UE power saving according to embodiments of the present disclosure. An embodiment of the method illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a method 2000 for throughput prediction, anomaly detection, and correction for 5G UE power saving may be used without departing from the scope of this disclosure.

As illustrated in FIG. 20, the method 2000 begins at step 2010. At step 2010, a UE receives and transmits traffic, over a time step, via a wireless network, based on a first set of radio frequency (RF) parameters. The RF parameters are received from a network device. At step 2020, the UE classifies the traffic received and transmitted over the time step into a traffic class. At step 1230, the UE selects a second set of RF parameters based on the traffic class. At step 2040, the UE estimates a throughput demand and a throughput supply. At step 2050, the UE determines whether an anomalous traffic condition has occurred. The determination is made based on the estimated throughput demand and the estimated throughout supply. If an anomalous traffic condition has not occurred, then at step 2060, the UE transmits a request to the network device to configure the UE with the second set of RF parameters. If an anomalous condition has occurred, then at step 2070 the UE transmits a request to the network device to configure the UE with a third set of RF parameters. The third set of RF parameters are selected to alleviate the anomalous traffic condition.

Although FIG. 20 illustrates one example of a2000 for throughput prediction, anomaly detection, and correction for 5G UE power saving, various changes may be made to FIG. 20. For example, while shown as a series of steps, various steps in FIG. 20 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive and transmit traffic, over a time step, via a wireless network (NW), based on a first set of radio frequency (RF) parameters received from a NW device; and
a processor operably coupled to the transceiver, the processor configured to:
classify the traffic received and transmitted over the time step into a traffic class;
select a second set of RF parameters based on the traffic class;
estimate a throughput demand and a throughput supply;
determine, based on the estimated throughput demand and the estimated throughput supply, whether an anomalous traffic condition has occurred;
if an anomalous traffic condition has not occurred, cause the transceiver to transmit a request to the NW device to configure the UE with the second set of RF parameters; and
if an anomalous traffic condition has occurred, cause the transceiver to transmit a request to the NW device to configure the UE with a third set of RF parameters selected to alleviate the anomalous traffic condition.

2. The UE of claim 1, wherein:
to determine that an anomalous traffic condition has not occurred, the processor is further configured to determine that the estimated throughput supply exceeds the estimated throughput demand by a threshold;
the processor is further configured to:
determine whether the first set of RF parameters are identical to the second set of RF parameters; and
determine whether a UAI timer has expired; and
the request to the NW device to configure the UE with the second set of RF parameters is transmitted based on:
a determination that the first set of RF parameters are not identical to the second set of RF parameters; and
a determination that the UAI timer has expired.

3. The UE of claim 1, wherein:
to determine that an anomalous traffic condition has occurred, the processor is further configured to determine that the estimated throughput supply fails to exceed the estimated throughput demand by a threshold;
the processor is further configured to:
determine whether the first set of RF parameters are identical to the third set of RF parameters; and
determine whether an anomaly timer has expired; and
the request to the NW device to configure the UE with the third set of RF parameters is transmitted based on:
a determination that the first set of RF parameters are not identical to the third set of RF parameters; and
a determination that the anomaly timer has expired.

4. The UE of claim 1, wherein the processor is further configured to:
determine a channel quality indicator (CQI); and
estimate, based on the CQI, a modulation coding scheme (MCS),
wherein, the MCS is estimated based on past observations of MCS for a given CQI, and
the throughput supply is estimated based on the estimated MCS.

5. The UE of claim 1, wherein to estimate the throughput demand, the processor is further configured to:
determine a present throughput observation corresponding to the traffic;
determine if a throughput observation database comprises more than one throughput observation;
if the throughput observation database fails to comprise more than one observation:
update the throughput observation database with the present throughput observation; and
if the throughput observation database comprises more than one throughput observation:
determine, based on a statistical analysis of the throughput observation database, a z score for the present throughput observation;
update, based on the z score, a value of a throughput observation counter; and
update the throughput observation database based on the updated value of the throughput observation counter;
wherein the throughput demand is estimated based on the updated throughput observation database.

6. The UE of claim 5, wherein the processor is further configured to:
if an absolute value of the updated value of the throughput observation counter is N, update the throughput observation database to retain only N most recent throughput observations; and
if an absolute value of the updated value of the throughput observation counter is less than N:
update the throughput observation database to include the present throughput observation; and
if the throughput observation database comprises at least K observations, update the throughput observation database to remove an oldest throughput observation,
wherein N indicates how many throughput observations should deviate from a result of the statistical analysis before determining that a present throughput has substantially changed from a previous throughput, and
wherein K is a large enough number to obtain a statistical analysis.

7. The UE of claim 1, wherein to estimate the throughput demand, the processor is further configured to:
determine a mean and a scaled standard deviation of a plurality of throughput observations comprised by a throughput observation database,
wherein the throughput demand is estimated based on the mean and the scaled standard deviation.

8. The UE of claim 1, wherein to estimate the throughput demand the processor is further configured to:
determine a mean and a percentile of a plurality of throughput observations comprised by a throughput observation database,
wherein the throughput demand is estimated based on the percentile.

9. The UE of claim 1, wherein to estimate the throughput demand, the processor is further configured to:
determine a transport block size (TBS) for all transport blocks transmitted over the time step;
normalize a total of the TBS for the transport blocks transmitted over the time step based on a size of the time step; and
normalize a total of the TBS for the transport blocks received over the time step based on the size of the time step,
wherein the throughput demand is estimated based on the normalized total of the TBS for the transport blocks transmitted over the time step and the normalized total of the TBS for the transport blocks received over the time step.

10. The UE of claim 1, wherein to estimate the throughput demand, the processor is further configured to:
determine a packet size for all packets comprising a five tuple including a process ID transmitted over the time step;
determine a packet size for all packets comprising a five tuple including a process ID received over the time step;
normalize a total of the packet sizes for the packets comprising a five tuple including a process ID transmitted over the time step based on a size of the time step; and
normalize a total of the packet sizes for the packets comprising a five tuple including a process ID received over the time step based on the size of the time step,
wherein the throughput demand is estimated based on the normalized total of the packet sizes for the packets comprising a five tuple including a process ID transmitted over the time step and the normalized total of the packet sizes for the packets comprising a five tuple including a process ID received over the time step.

11. The UE of claim 1, wherein to estimate the throughput demand the processor is further configured to:
segregate all packets comprising a five tuple including a process ID transmitted over the time step into real time (RT) uplink (UL) packets and non-real time (NRT) UL packets;
segregate all packets comprising a five tuple including a process ID received over the time step into RT downlink (DL) packets and NRT DL packets;
determine a packet size for all RT UL packets;
determine a packet size for all NRT UL packets;
determine a packet size for all RT DL packets;
determine a packet size for all NRT DL packets;
normalize a total of the packet sizes for the RT UL packets based on a size of the time step; and
normalize a total of the packet sizes for the NRT UL packets based on the size of the time step;
normalize a total of the packet sizes for the RT DL packets based on the size of the time step; and
normalize a total of the packet sizes for the NRT DL packets based on the size of the time step,
wherein the throughput demand is estimated based on the normalized totals of the packet sizes for the RT UL packets, the NRT UL packets, the RT DL packets, and the NRT DL packets.

12. A method of operating a user equipment (UE), the method comprising:
receiving and transmitting traffic, over a time step, via a wireless network (NW), based on a first set of radio frequency (RF) parameters received from a NW device;
classifying the traffic received and transmitted over the time step into a traffic class;
selecting a second set of RF parameters based on the traffic class;
estimating a throughput demand and a throughput supply;
determining, based on the estimated throughput demand and the estimated throughput supply, whether an anomalous traffic condition has occurred;
if an anomalous traffic condition has not occurred, transmitting a request to the NW device to configure the UE with the second set of RF parameters; and
if an anomalous traffic condition has occurred, transmitting a request to the NW device to configure the UE with a third set of RF parameters selected to alleviate the anomalous traffic condition.

13. The method of claim 12, wherein:
to determine that an anomalous traffic condition has not occurred, the method further comprises:
determining that the estimated throughput supply exceeds the estimated throughput demand by a threshold;
the method further comprises:
determining whether the first set of RF parameters are identical to the second set of RF parameters; and
determining whether a UAI timer has expired; and
the request to the NW device to configure the UE with the second set of RF parameters is transmitted based on:
determining that the first set of RF parameters are not identical to the second set of RF parameters; and
determining that the UAI timer has expired.

14. The method of claim 12, wherein:
to determine that an anomalous traffic condition has occurred, the method further comprises:
determining that the estimated throughput supply fails to exceed the estimated throughput demand by a threshold;
the method further comprises:
determining whether the first set of RF parameters are identical to the third set of RF parameters; and
determining whether an anomaly timer has expired; and
the request to the NW device to configure the UE with the third set of RF parameters is transmitted based on:
determining that the first set of RF parameters are not identical to the third set of RF parameters; and
determining that the anomaly timer has expired.

15. The method of claim 12, further comprising:
determining a channel quality indicator (CQI); and
estimating, based on the CQI, a modulation coding scheme (MCS),
wherein, the MCS is estimated based on past observations of MCS for a given CQI, and
the throughput supply is estimated based on the estimated MCS.

16. The method of claim 12, wherein estimating the throughput demand comprises:
determining a present throughput observation corresponding to the traffic;
determining if a throughput observation database comprises more than one throughput observation;
if the throughput observation database fails to comprise more than one observation:
updating the throughput observation database with the present throughput observation;
if the throughput observation database comprises more than one throughput observation:
determining, based on a statistical analysis of the throughput observation database, a z score for the present throughput observation;
updating, based on the z score, a value of a throughput observation counter; and
updating the throughput observation database based on the updated value of the throughput observation counter;
if an absolute value of the updated value of the throughput observation counter is N, updating the throughput observation database to retain only N most recent throughput observations;
if an absolute value of the updated value of the throughput observation counter is less than N:
updating the throughput observation database to include the present throughput observation; and
if the throughput observation database comprises at least K observations, updating the throughput observation database to remove an oldest throughput observation,
wherein N indicates how many throughput observations should deviate from a result of the statistical analysis before determining that a present throughput has substantially changed from a previous throughput;
wherein K is a large enough number to obtain a statistical analysis; and
wherein the throughput demand is estimated based on the updated throughput observation database.

17. The method of claim 12, wherein estimating the throughput demand comprises:
determining a mean and a scaled standard deviation of a plurality of throughput observations comprised by a throughput observation database,
wherein the throughput demand is estimated based on the mean and the scaled standard deviation.

18. The method of claim 12, wherein estimating the throughput demand comprises:
determining a mean and a percentile of a plurality of throughput observations comprised by a throughput observation database,
wherein the throughput demand is estimated based on the percentile.

19. The method of claim 12, wherein estimating the throughput demand comprises:
determining a transport block size (TBS) for all transport blocks transmitted over the time step;
normalizing a total of the TBS for the transport blocks transmitted over the time step based on a size of the time step; and
normalizing a total of the TBS for the transport blocks received over the time step based on the size of the time step,
wherein the throughput demand is estimated based on the normalized total of the TBS for the transport blocks transmitted over the time step and the normalized total of the TBS for the transport blocks received over the time step.

20. The method of claim 12, wherein estimating the throughput demand comprises:
determining a packet size for all packets comprising a five tuple including a process ID transmitted over the time step;
determining a packet size for all packets comprising a five tuple including a process ID received over the time step;
normalizing a total of the packet sizes for the packets comprising a five tuple including a process ID transmitted over the time step based on a size of the time step; and
normalizing a total of the packet sizes for the packets comprising a five tuple including a process ID received over the time step based on the size of the time step,
wherein the throughput demand is estimated based on the normalized total of the packet sizes for the packets comprising a five tuple including a process ID transmitted over the time step and the normalized total of the packet sizes for the packets comprising a five tuple including a process ID received over the time step.
